(19) United States
(12) Patent Application Publication
(10) Pub. No.: US 2006/0208865 A1
(43) Pub. Date: Sep. 21, 2006

(54) Bluetooth tire pressure monitor system

(76) Inventors: Tuan Quach, Mira Loma, CA (US); Tony Quach, Hayward, CA (US); Yanxia Guo, Phoenix, AZ (US)

Correspondence Address: INTELLECTUAL PROPERTY LAW OFFICES, 1901 S. BASCOM AVENUE, SUITE 660, CAMPBELL, CA, 95008, US

(21) Appl. No.: 11/290,624

(22) Filed: Nov. 30, 2005

Related U.S. Application Data
(60) Provisional application No. 60/522,987, filed on Nov. 30, 2004.

(51) Int. Cl. B60C 23/00; B60C 23/02

(52) U.S. Cl. 340/447; 73/146.5; 116/34 B

(57) ABSTRACT

The Bluetooth tire pressure monitor system (10) is provided to mount on the various tires (11) of a vehicle, The system (10) includes a pressure sensor (12), a signal emitter (13), a display screen (14) and a signal receiver (15). The pressure sensor (12) and emitter (13) are integrated with a customized inflating valve (21) and installed in the tire (11). The signal receiver (15) and display screen/user interface (14) are placed in the driver's compartment (16) of the vehicle in a highly visible location, usually on the dashboard. The pressure sensor (12) senses the pressure in the tire (11). The signal emitter (13) collects and converts the pressure signal from the pressure sensor (12) and transmits the signal wirelessly (using the Bluetooth protocol) to signal receiver (15) which converts the signal and delivers it to the user interface/display screen (14) which displays the signal. The signal receiver (15) and display screen (14) are shared components, signal receiver (15) distinguishes and identifies all frequencies (50) from the associated signal emitter (13) of each tire (11) first, then addresses the signals to the matching tire of display screen (14). The display screen (14), usually in the from of an adhesively attached film-shape, indicates the position and pressure condition of all tires. The condition is preferably shown in red, yellow and green colors based on the air pressure range. When the range is 76-100%, the indicating light is green (38), when the range is 50-75%, the indicating light is yellow (39) and when it is lower than 50%, indicating light is red (40. The inflating valve (21) of the Bluetooth Tire Pressure Monitor System (10), includes a valve cap 31, a valve rod 32, a single direction valve 33, a spring 34, a support 35, the pressure sensor 12 and the emitter 13, along with a battery 36 to power the sensor and emitter.

The following claims priority from a provisional patent application 60/522,987, filed 30 Nov. 2004 to one of the same inventors.

### BACKGROUND OF THE INVENTION

The present invention relates to motor vehicle safety field, and more particularly to a vehicle Bluetooth Tire Pressure Monitor System. It pertains to all new motor vehicles' development and existing motor vehicles.

Recent decade, accompanying automobile's development, more and more vehicles are running on the road. Three hundred twenty million motor vehicles registered in United States in year 2004 only. Those many running vehicles cause numerous traffic accidents. It is big percentage that because of flat tire and fire. According to statistics, the lifetime of the tire may reduce to 50% and fuel cost may increase up to 30% because of improper tire pressure.

In some developed countries, from government to consumers, people have paid much attention on this issue. As a result of recent legislation of US that all motor vehicles should install the tire pressure monitor system by 2007, a large market of tire pressure monitor has been created.

As a purchasing option, several larger automobile manufactures have developed few tire pressure monitor systems for some high class new cars. They mainly use wired control or radio wireless control. It is easy to install to utilize the reserved interface for new cars. For after-market assembly, existing motor vehicles, it is not easy.

### SUMMARY OF THE INVENTION

Accordingly, it is the general purpose and object of the present invention to provide a vehicle tire pressure monitor system with basic tire pressure warning functionality and convenience in installation, convenience in use and convenience in maintenance. By monitoring and controlling air pressure within the tire at proper values, the goals of increased tire lifetime, reduced fuel cost and lower vehicle accident rates caused by flat tires and fire can be achieved. The present invention is suitable for all vehicles having from four to twelve tires; and systems may be combined for extension purpose.

In accordance with one preferred aspect of the invention, the Bluetooth tire pressure monitor system consists of a pressure sensor, a signal emitter, a signal receiver and a display screen. The pressure sensor and signal emitter are integrated with inflating valve, it is installed within the tire; and the signal receiver and user interface are placed in driver's compartment.

The pressure sensor 12 measures air pressure within the tire; signal emitter 13 collects the pressure signal from pressure sensor 12 and emits wirelessly to the signal receiver 15; the control modules (designed by Bluetooth Technology), are placed into the signal emitter 13 and signal emitter 15 correspondingly. The signal receiver 15 picks up the signal from signal emitter 13 of each tire, and distinguishes and identifies the frequency, then transmits to user interface and addresses the signals to the matching tire.

The user interface 14 indicates all positions of each tire and three LED display the air pressure ranges. Based on the pressure range of each tire, the readouts are displayed in three colors which are red, yellow and green. When the pressure range is 76-100%, the green LED is lit and tells the user that pressure is proper; when the pressure is 50-75%, the yellow LED is lit and the user is warned that pressure is low; when the pressure is lower than 50%, red LED is lit to warn the user that pressure is seriously below operational levels.

When installing the Bluetooth Tire Pressure Monitor System, it is necessary to just replace the original inflating valve with inflating vale 21 on each tire 11 without requiring ant extra connecting device.

These and other features, aspects and advantages of the present invention will become better understood with reference to the following drawings, description and claims.

### BRIEF DESCRIPTION OF THE DRAWINGS

FIG. 1 is a fanciful schematic illustration to show the Bluetooth Tire Pressure Monitor System control principle;

FIG. 2 is a perspective view of a typical tire showing the method of installing the present invention;

FIG. 3 is a cross sectional view showing the structure and components of the inflating valve of the invention;

FIG. 4.1 is a diagram which illustrates a typical user interface (display) for a vehicle with four tires, with the active display being keyed to the right rear tire;

FIG. 4.2 is similar to FIG. 4.1 showing the display for a six-wheeled vehicle;

FIG. 4.3 is similar to FIG. 4.1 showing the display for a ten-wheeled vehicle (truck);

FIG. 4.4 is similar to FIG. 4.1 showing the display for a ten-wheeled vehicle (bus);

FIG. 4.5 is similar to FIG. 4.1 showing the display for an eight-wheeled vehicle (trailer);

FIG. 4.6 is similar to FIG. 4.1 showing the display for a ten-wheeled vehicle (truck).

### DETAILED DESCRIPTION OF THE INVENTION

The following detailed description is of the best modes of carrying out the invention. The description is not to be taken in a limiting sense, but is made merely for the purpose of illustrating the general principles of the invention, since the scope of the invention is best defined by the appended claims.

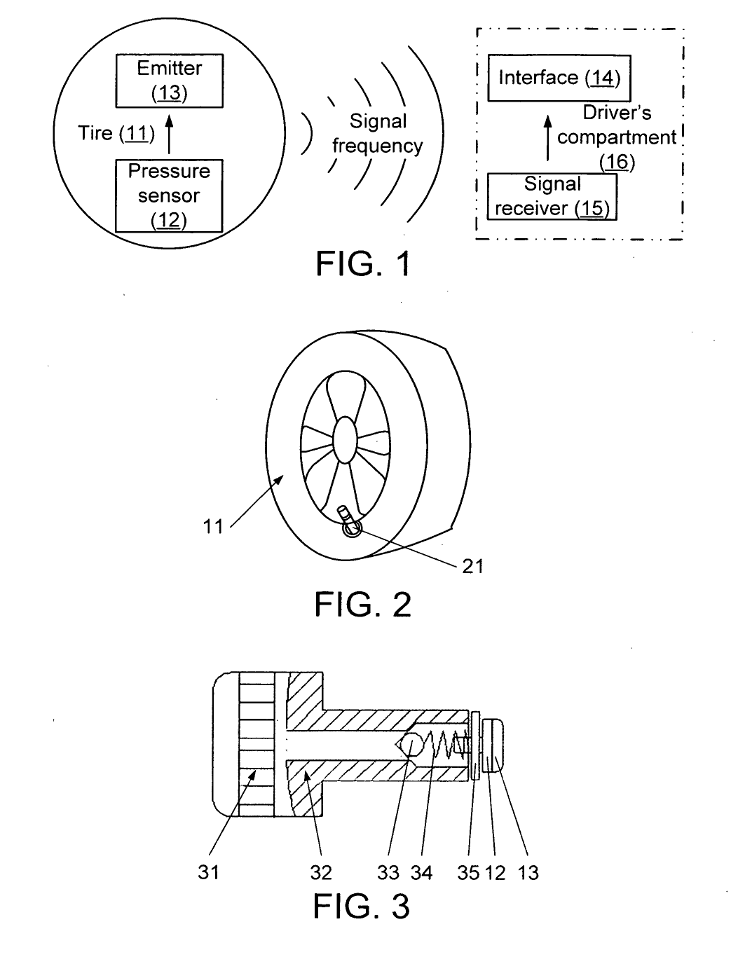

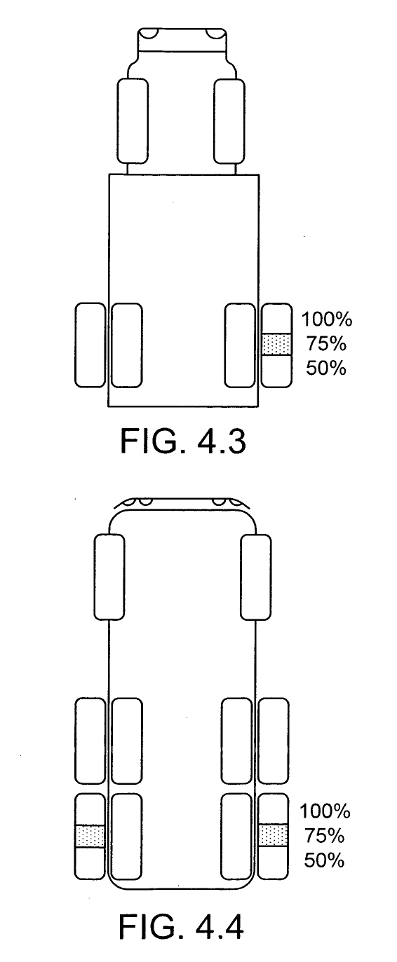

With reference to the drawings, FIG. 1 illustrates the control principle of the preferred embodiment of the invention, a Bluetooth Tire Pressure Monitor System 10. The system 10 includes a pressure sensor 12, a signal emitter 13, a user interface 14 and a signal receiver 15. The pressure sensor 12 and the signal emitter 13 are integrated with an inflating valve 21 (see FIG. 3) which installed within tire 11, and the user interface 14 and the signal receiver 15 are situated in the driver's compartment 16, usually on the dasboard.

The pressure sensor 12 measures the air pressure within the tire 11. According to Bluetooth wireless control principles, two control modules are respectively placed in the signal emitter 13 and the signal receiver 15. Signal emitter 13 collects the pressure signal from pressure sensor 12 and emits it wirelessly to the signal receiver 15. The signal receiver 15 picks up the signal from the signal emitter 13 of each tire; distinguishes and identifies each by the selected differential frequency, then transmit the signals to the user interface 14 for displays associated with each matching tire.

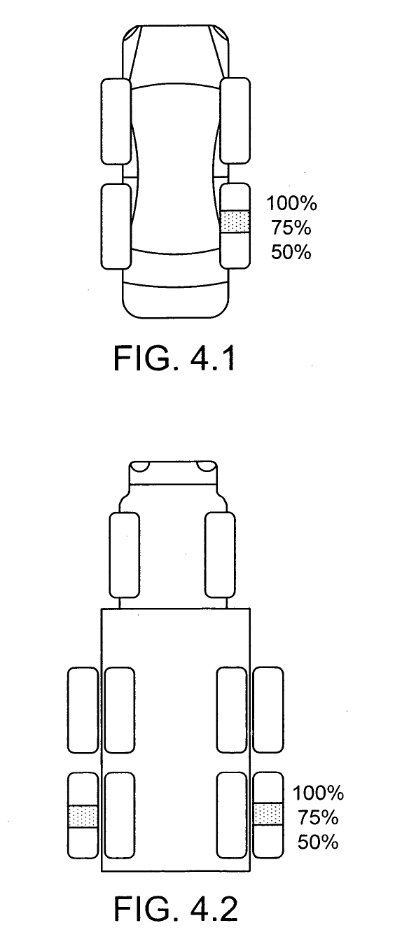

FIG. 2 illustrates the mounting method of Bluetooth Tire Pressure Monitor System 10 upon a tire 11. When installing this system, the only operation required is the replacement of the original inflating valve of tire 11 with the inventive inflating valve 21 of the present invention/ This does not require any special tools or connecting device.

FIG. 3 illustrates the structure of inflating valve 21 of the Bluetooth Tire Pressure Monitor System 10. The preferred inflating valve 21 includes a valve cap 31, a valve rod 32, a single direction valve 33, a spring 34, a support 35, and the pressure sensor 12 and emitter 13 described above. When inflating the tire 11 by forcing pressurized air through inflating valve 21, the air pressure depresses spring 34, such that the single direction valve 33 opens the air channel. When inflation is completed or stopped, the pressure within tire 11 is greater than external air pressure, and the combination of the internal pressure and the spring 34 cause the single direction valve 33 to close the air channel to protect air leakage. The pressure sensor 12 and emitter 13 are integrated with valve 21. A micro battery 36 is utilized as a power source.

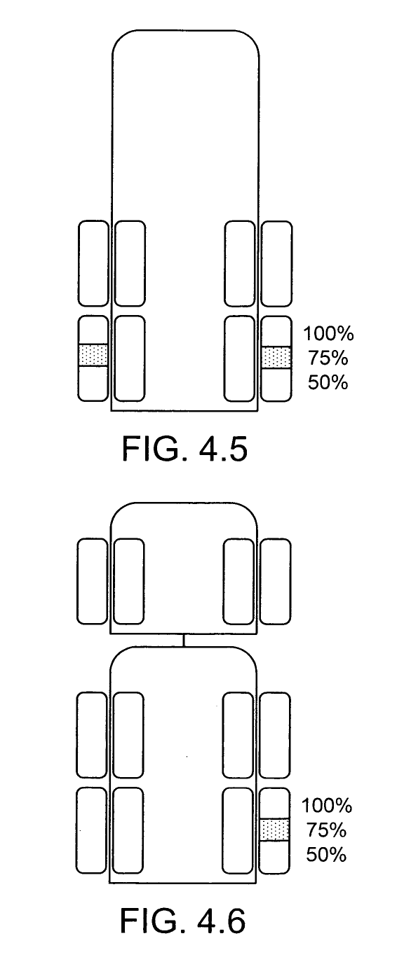

FIG. 4 is a series of illustrations showing how the display of the conditions of the pressure conditions in each tire appears for various types of tire configurations and vehicles. FIG. 4.1-FIG. 4.6 illustrate the appearance of the user interface of the Bluetooth Tire Pressure Monitor System, with each showing a moderately low pressure condition in the outermost right rear tire. The user interface 14 is a film-shape and can be attached adhesively on a meter panel in driver's compartment, typically on the dashboard. The user interface 14 displays the positions and pressure of each tire in a vehicle. Each user interface 14 is customized for the type of vehicle and the six most common configurations are illustrated in the drawing. Each user interface 14 includes three LED segments 37 for each tire. These are selected to indicate the general condition and include a green segment 38, a yellow segment 39 and a red segment 40. Based on the pressure range of each tire, the appropriate LED 37 will be highlighted. When the pressure range is 76-100%, the green LED 38 is lit to tell the pressure is proper, or at least not dangerously low. When the pressure range is 50-75%, the yellow LED 39 is lit to tell that tire pressure is becoming dangerously low and when the pressure is lower than 50%, the red LED 40 is lit to warn the operator that the pressure is dangerously low and immediate attention is needed.

Since the signal receiver 15 picks up all pressure signals from the associated emitter 13 in each tire at the same time, it is necessary to distinguish and identify the signal frequency 50 first, then address the condition signal to the corresponding display screen 14. With reference of FIG. 4.1-FIG. 4.6; the displays are shown, respectively for four tires, six tires, a ten tire vehicle and a ten tires bus, as well as for eight tire and twelve tire trailers. For each system 10 a number of selected frequencies 50(1) through 50(x) is provided, with x being equal to the number of tires in the system.

It should be understood, of course, that the foregoing relates to preferred embodiments of the invention and those modifications may be made without departing from the spirit and scope of the invention as set forth in the following claims.

We claim:

1. A tire pressure monitoring system for a vehicle comprising:
an inflating valve for placement in each tire of the vehicle, said inflating valve including a pressure sensor and an emitter for generating a specific wireless signal based on the output of said sensor;
a signal receiver/processor, situated remotely from said tires, for receiving each said specific wireless signal, identifying which tire from which such signal is generated and generating a display output associated therewith; and
a user interface/display associated with each said tire, each said user interface/display being situated in visual range of the operator of the vehicle, for visually displaying said display output such that the operator is made aware of the pressure condition in each said tire.

2. The tire pressure monitoring system of claim 1, wherein
said user interface/display includes color separated segments corresponding to normal pressure, marginal pressure and dangerously low pressure.

3. The tire pressure monitoring system of claim 2, wherein
said color separated segments are green for said normal pressure condition, yellow for said marginal pressure condition and red for said dangerously low pressure condition.

4. The tire pressure monitoring system of claim 2, wherein
said user interface/display includes a schematic diagram of the vehicle showing the position of each tire, with a set of said color separated segments associated with each tire location.

5. The tire pressure monitoring system of claim 1, wherein
said user interface/display includes LED segments.

6. The tire pressure monitoring system of claim 1, wherein
each said emitter is selected to generate a respective one of said wireless signals at a different frequency from each other one of said emitters; and
said signal receiver/processor recognizes the location of each said emitter by the frequency of said wireless signal.
